(19) United States
(12) Patent Application Publication
(10) Pub. No.: US 2023/0246281 A1
(43) Pub. Date: Aug. 3, 2023

(54) BATTERY HOUSING STRUCTURE AND WORK MACHINE

(71) Applicant: Honda Motor Co., Ltd., Tokyo (JP)

(72) Inventors: Hideshi Sasaki, Wako-shi (JP); Fumio Minami, Wako-shi (JP); Jun Song, Wako-shi (JP)

(21) Appl. No.: 18/101,203

(22) Filed: Jan. 25, 2023

(30) Foreign Application Priority Data
Jan. 31, 2022 (JP) 2022-013484

(51) Int. Cl. H01M 50/264; H01M 50/249; H01M 50/588; H01M 50/244; H01M 50/271; B60L 50/60

(52) U.S. Cl. CPC H01M 50/264; H01M 50/249; H01M 50/588; H01M 50/244; H01M 50/271; B60L 50/66; H01M 2220/20; B60L 2200/40; A01D 34/81

(57) ABSTRACT

Battery housing structure, includes: housing portion configured to house battery-unit including first-connector; second-connector configured to be connected to first-connector; and fixing tool configured to fix battery-unit to housing portion and including connection prevention portion configured to prevent connection between first-connector and second-connector when located at connection prevention position. Battery-unit includes concave portion facing inner wall of housing portion. Fixing tool is swing lever including projection at one end and connection prevention portion at other end, and configured to swing about shaft provided between one end and other end. Swing lever is configured to swing between: first position where projection is engaged with concave portion and battery-unit is fixed to housing portion; and second position where projection is not engaged with concave portion and connection prevention portion is located at connection prevention position, in accordance with amount of insertion of battery-unit into housing portion.

### CROSS-REFERENCE TO RELATED APPLICATION

This application is based upon and claims the benefit of priority from Japanese Patent Application No. 2022-013484 filed on Jan. 31, 2022, the content of which is incorporated herein by reference.

### BACKGROUND OF THE INVENTION

### Field of the Invention

This invention relates to a battery housing structure and a work machine.

### Description of the Related Art

Conventionally, a work machine having a detachable battery is known (see, e.g., WO 2020/194728 A1 (JPWO 2020/194728 A1)). In the work machine described in JPWO 2020/194728 A1, the battery is placed on a battery tray attached to an upper portion of a power unit main body. From the power unit main body, a cable provided with a connection terminal at its tip end is drawn out to the outside. To connect the battery to the power unit main body, the user manually connects the connection terminal to a connector provided in the connection of the battery.

As described above, in the configuration in which the connection terminal of the cable drawn out to the outside is connected to the connector on the battery side, since the cable is freely bent, the connection terminal may be damaged by colliding with an obstacle when the battery is placed on the battery tray. In addition, there is a possibility that the connection terminal is erroneously connected before the battery is fixed, and in this case, there is a possibility that a malfunction occurs.

### SUMMARY OF THE INVENTION

An aspect of the present invention is a battery housing structure, including: a housing portion configured to house a battery unit including a first connector; a second connector configured to be connected to the first connector; and a fixing tool configured to fix the battery unit to the housing portion and including a connection prevention portion configured to prevent connection between the first connector and the second connector when located at a connection prevention position. The battery unit includes a concave portion facing an inner wall of the housing portion. The fixing tool is a swing lever including a projection at one end and the connection prevention portion at the other end, and configured to swing about a shaft provided between the one end and the other end. The swing lever is configured to swing between: a first position where the projection is engaged with the concave portion and the battery unit is fixed to the housing portion; and a second position where the projection is not engaged with the concave portion and the connection prevention portion is located at the connection prevention position, in accordance with an amount of insertion of the battery unit into the housing portion.

Another aspect of the present invention is a work machine, including: the battery housing structure. The housing portion and the fixing tool are disposed along a moving direction of the work machine.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of a work machine according to a first embodiment;

FIG. 2 is a perspective view illustrating a lower housing portion in a state in which an opening/closing portion is removed;

FIG. 3 is a diagram illustrating a detailed structure of a battery housing portion;

FIG. 4 is a diagram of a battery unit as viewed from front side of the work machine;

FIG. 5 is a perspective view of a lock lever and a connector holding portion as viewed obliquely from the right rear side;

FIG. 6 is a perspective view of the lock lever and the connector holding portion as viewed obliquely from the right front side;

FIG. 7A is a diagram illustrating a slide mechanism for the connector holding portion in a state in which the connector holding portion has moved to a retracted end;

FIG. 7B is a diagram illustrating the slide mechanism for the connector holding portion in a state in which the connector holding portion has moved to an advanced end;

FIG. 8 is a diagram for explaining a carrying-in operation of the battery unit;

FIG. 9A is a diagram for explaining a step 1 of a housing operation of the battery unit;

FIG. 9B is a diagram for explaining a step 2 of the housing operation of the battery unit;

FIG. 9C is a diagram for explaining a step 3 of the housing operation of the battery unit;

FIG. 10 is a diagram illustrating a positional relationship between a second engaging portion and a notch in the steps 1 to 3;

FIG. 11 is a cross-sectional view taken along line B-B of FIG. 9C;

FIG. 12 is a diagram illustrating a lock lever and a connector holding portion according to a second embodiment;

FIG. 13 is a cross-sectional view taken along line C-C of FIG. 12; FIG. 14 is a perspective view of a barrier wall of the lock lever;

FIG. 15 is a diagram illustrating a slide structure of the connector holding portion;

FIG. 16 is a cross-sectional view taken along line D-D of FIG. 15;

FIG. 17A is a diagram for explaining a step 1 of a housing operation of the battery unit according to the second embodiment;

FIG. 17B is a diagram for explaining a step 2 of the housing operation of the battery unit according to the second embodiment;

FIG. 17C is a diagram for explaining a step 3 of the housing operation of the battery unit according to the second embodiment;

FIG. 18 is a perspective view of a lock lever according to a modification;

FIG. 19 is a cross-sectional view illustrating a relationship between the lock lever and a battery unit according to the modification;

FIG. 20 is a cross-sectional view in a released state; and

FIG. 21 is a diagram illustrating a positional relationship between a second engaging portion and a notch in a case in which the modification is used in the lock lever in the first embodiment.

### DETAILED DESCRIPTION OF THE INVENTION

Hereinafter, embodiments of the present invention will be described below with reference to the drawings. The following description and drawings are examples for describing the present invention, and omissions and simplifications are made as appropriate for the sake of clarity of the description. In addition, in the following description, the same or similar elements and processes are denoted by the same reference numerals, and redundant description may be omitted. Note that the contents described below are merely examples of the embodiments of the present invention, and the present invention is not limited to the following embodiments, and can be implemented in other various forms.

### First Embodiment

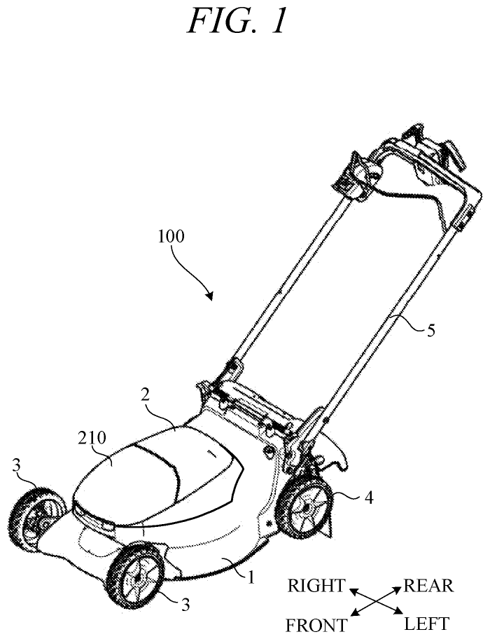

FIG. 1 is a diagram illustrating an example of a work machine according to a first embodiment, and illustrating an appearance of a lawn mower 100. The lawn mower 100 includes a work unit cover 1 that covers a lawn mowing work unit for mowing a lawn, a power unit 2 including a motor, a battery unit, and the like, a pair of front wheels 3, a pair of rear wheels 4, and a handle 5. The lawn mower 100 travels in the front-rear direction of the lawn mower 100. An openable/closable opening/closing portion 210 is provided on an upper surface of the power unit 2.

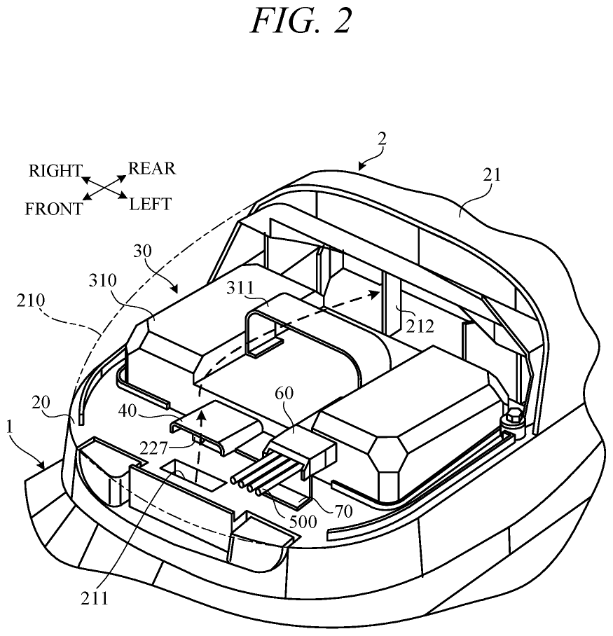

FIG. 2 is a perspective view illustrating the power unit 2 in a state in which the opening/closing portion 210 (indicated by a two-dot chain line) is removed. The power unit 2 includes a lower housing portion 20 in which the battery unit 30 and the motor (not illustrated) are housed, and an upper cover 21 provided on an upper portion of the lower housing portion 20. The opening/closing portion 210 is provided in the upper cover 21. The upper cover 21 has a guide 212 for mounting the battery unit. In the lower housing portion 20, a lock lever 40 and a connector holding portion 60 are disposed at positions facing the front surface of the battery unit 30. The lock lever 40 is swingably attached to a shaft 403 supported by support columns 227 provided on the lower housing portion 20.

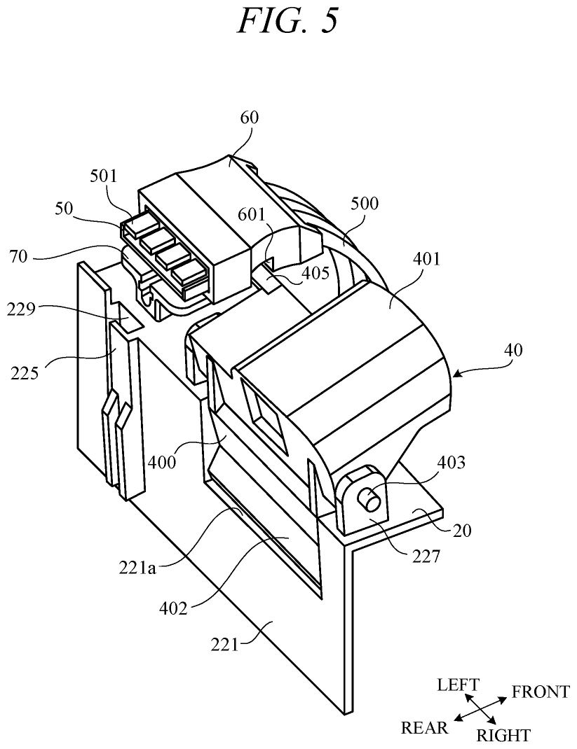

The connector holding portion 60 is attached to a support portion 70 fixed to the lower housing portion 20 with a bolt or a screw so as to be slidable in the front-rear direction. The connector holding portion 60 holds a work machine-side connector portion 50 (see FIG. 5). The connector portion 50 is connected to a device on the power unit 2 side by a cable 500. An intake port 211 is provided in a front portion of the power unit 2. Air that flows into the lawn mower 100 from the intake port 211 flows rearward in a region present above the battery unit 30 as indicated by a broken line arrow, and flows into a region where the motor and the like are disposed.

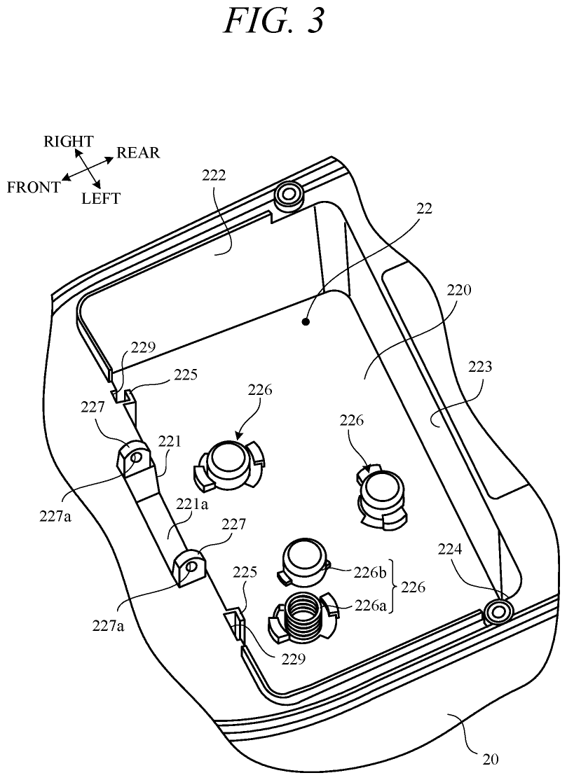

FIG. 3 is a diagram illustrating a detailed structure of a battery housing portion 22 in which the battery unit 30 is housed. The battery housing portion 22 provided in the lower housing portion 20 is a substantially rectangular parallelepiped concave portion formed by a bottom surface 220 and four inner walls 221, 222, 223, and 224 erected from the bottom surface 220. On the bottom surface 220, three urging portions 226 for urging the housed battery unit 30 toward the inlet side (upper side) of the battery housing portion 22 are provided. Each of the urging portions 226 includes a compression coil spring 226a and a cap 226b covering an upper portion of the compression coil spring 226a.

On the inner wall 221 provided on the front side of the battery housing portion 22 in the front-rear direction (that is, the front-rear direction of the lawn mower 100), a pair of projections 225 and a pair of concave portions 229 are formed with a concave portion 221a interposed therebetween and formed on the inner wall 221. The support columns 227 that support the shaft 403 (see FIG. 5) (not illustrated) to which the lock lever 40 is attached are provided in front of the battery housing portion 22. Through holes 227a through which the shaft 403 is inserted are formed in the support columns 227.

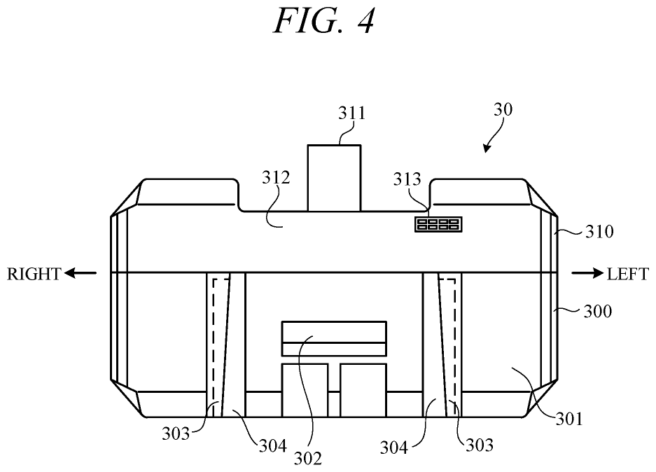

FIG. 4 is a diagram of the battery unit 30 as viewed from the front side of the work machine. The battery unit 30 includes an upper casing 310 and a lower casing 300, and a battery (not illustrated) is housed in the casings 300 and 310. A handle 311 is provided on an upper surface of the upper casing 310. On a side surface 312 of the upper casing 310 on the front side of the work machine, a connector portion 313 to be connected to the connector portion 50 on the work machine side in FIG. 5 to be described later is disposed. A concave portion 302 is formed on a front-side side surface 301 of the lower casing 300. A pair of projections 303 and a pair of concave portions 304 are formed on both sides of the concave portion 302.

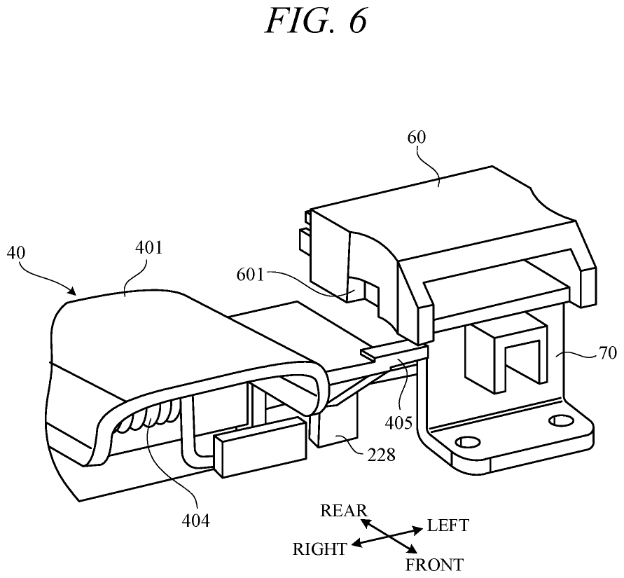

FIGS. 5 and 6 are enlarged views of a portion including the lock lever 40 and the connector holding portion 60. FIG. 5 is a perspective view of the lock lever 40 and the connector holding portion 60 as viewed obliquely from the right rear side. FIG. 6 is a perspective view of the lock lever 40 and the connector holding portion 60 as viewed obliquely from the right front side. The connector holding portion 60 is disposed near the left side of the lock lever 40.

The lock lever 40 includes a lever main body 400 and an operation portion 401. The lock lever 40 is swingably attached to the shaft 403. Both ends of the shaft 403 are inserted into the through holes 227a of the pair of support columns 227 illustrated in FIG. 3. The lever main body 400 of the lock lever 40 attached to the shaft 403 is disposed in the concave portion 221a formed in the inner wall 221. In a tip end region of the lever main body 400, a first engaging portion 402 which is an engaging projection protruding toward the battery housing portion 22 (that is, the rear side of the work machine) is formed. A second engaging portion 405 is formed on the left side of the operation portion 401 so as to protrude toward the connector holding portion 60 (that is, toward the left direction).

As illustrated in FIG. 6, a torsion spring 404 is attached to the shaft 403. The torsion spring 404 applies a force for swinging the lock lever 40 clockwise in FIG. 5 to the lock lever 40. When the lock lever 40 is in a free state without being operated, the operation portion 401 abuts on a stopper 228 illustrated in FIG. 6, and the lock lever 40 is positioned at a predetermined initial position.

The connector holding portion 60 that holds the connector portion 50 is supported by the support portion 70. The support portion 70 is fixed to the lower housing portion 20 with a bolt or a screw. The connector holding portion 60 is provided so as to be slidable on the support portion 70 in the front-rear direction. The connector portion 50 is provided with a connection terminal 501. A notch 601 is formed on a side surface of the connector holding portion 60 on the lock lever side. When the lock lever 40 is at a swing position illustrated in FIG. 5, the second engaging portion 405 of the operation portion 401 is in a state of being engaged with the notch 601 of the connector holding portion 60. On the other hand, when the lock lever 40 is at a swing position illustrated in FIG. 6, the second engaging portion 405 is in a state of being disengaged from the notch 601.

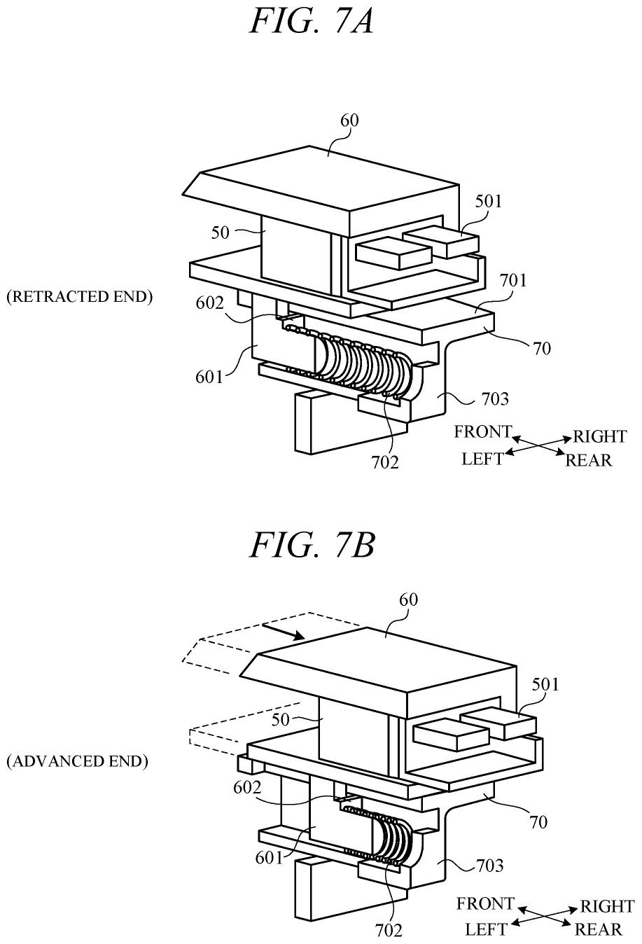

FIGS. 7A and 7B are diagrams illustrating a slide mechanism for the connector holding portion 60. The connector holding portion 60 is provided so as to be slidable on the support portion 70 in the front-rear direction of the work machine. Hereinafter, a position where the connector holding portion 60 has moved to the front side of the work machine the most is referred to as a retracted end. On the other hand, a position where the connector holding portion 60 moves to the rear side of the work machine and can be connected to the connector portion 313 of the battery unit 30 is referred to as an advanced end. FIG. 7A illustrates a state in which the connector holding portion 60 has moved to the retracted end, and FIG. 7B illustrates a state in which the connector holding portion 60 has moved to the advanced end.

The connector holding portion 60 is placed on the upper surface 701 of the support portion 70. The support portion 70 includes a spring housing portion 703 provided with a compression coil spring 702 below the upper surface 701. An L-shaped member 601 to be inserted into a rear end (left side end in FIGS. 7A and 7B) of the compression coil spring 702 is formed at a lower portion of the connector holding portion 60. The L-shaped member 601 is urged toward the retracted end (front side of the work machine) by the compression coil spring 702. A claw portion 602 protruding in the left-right direction of the L-shaped member 601 is formed on the L-shaped member 601. The connector holding portion 60 can slide back and forth on the upper surface 701 of the support portion 70, but the vertical movement of the connector holding portion 60 is restricted by the claw portion 602.

In a free state in which the operator does not operate the connector holding portion 60, the connector holding portion 60 is positioned at the retracted end by the compression coil spring 702 as illustrated in FIG. 7A. On the other hand, when the connector portion 50 is connected to the connector portion 313 of the battery unit 30, the operator manually slides the connector holding portion 60 toward the advanced end side (rear side of the work machine) to move the connector holding portion 60 to the advanced end illustrated in FIG. 7B.

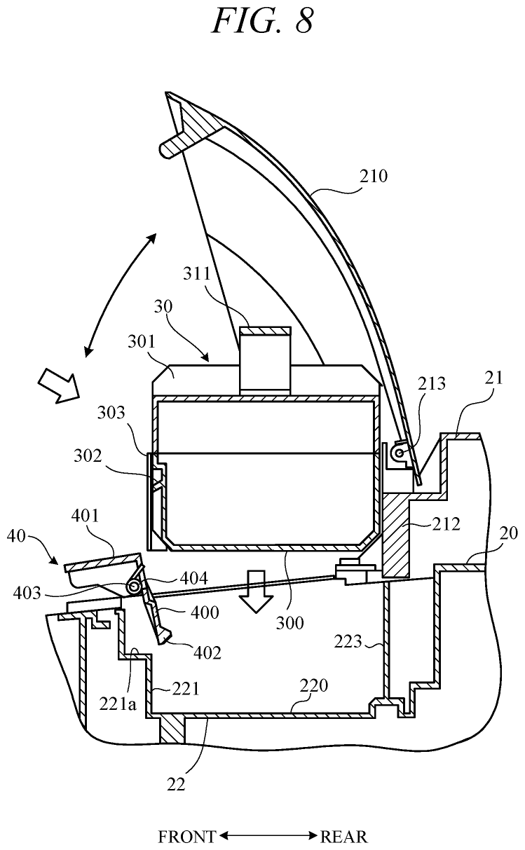

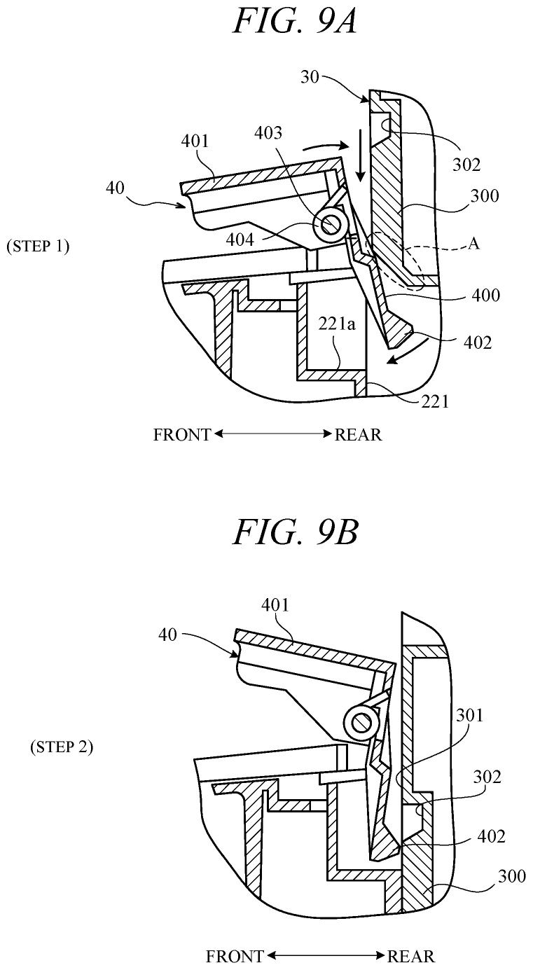

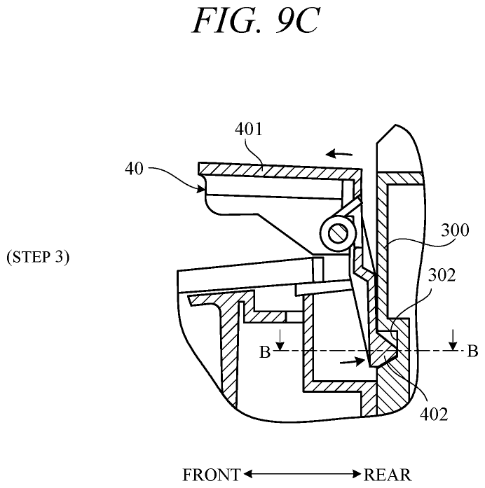

FIGS. 8, 9A, and 9B are diagrams for describing an operation of housing the battery unit 30 in the battery housing portion 22 of the lower housing portion 20. In FIGS. 8, 9A, and 9B, the lock lever 40 provided on the front side of the battery housing portion 22 is urged by the torsion spring 404 counterclockwise in the drawings. In a free state in which the lock lever 40 is not operated, the operation portion 401 of the lock lever 40 abuts on the stopper 228 (see FIG. 6) as described above, and the lock lever 40 is positioned at the initial position illustrated in FIG. 8. At this initial position, the first engaging portion 402 of the lock lever 40 protrudes rightward (toward the rear side of the work machine) with respect to the inner wall 221 in FIG. 8, that is, protrudes into the housing space of the battery housing portion 22.

As illustrated in FIG. 8, the opening/closing portion 210 provided in the upper cover 21 opens and closes with a shaft 213 provided on the rear side of the work machine with respect to the battery housing portion 22 as a rotation axis. To house the battery unit 30 in the battery housing portion 22, the opening/closing portion 210 is opened as illustrated in FIG. 8, and the battery unit 30 is carried into the battery housing portion 22 from the diagonally front side as indicated by the arrow with the handle 311 held. In this case, by bringing the back surface of the battery unit 30 into contact with the guide 212 of the upper cover 21, positioning in the depth direction of the work machine when the battery unit 30 is carried into the battery housing portion 22 becomes easy.

FIGS. 9A to 9C are diagrams for explaining an operation of housing the battery unit 30. As illustrated in FIG. 8, when the battery unit 30 is lowered to the battery housing portion 22 of the lower housing portion 20 along the guide 212, a lower end A of the battery unit 30 abuts on the lever main body 400 of the lock lever 40 in the initial position state as illustrated in step 1 of FIG. 9A.

When the battery unit 30 is further lowered from the state illustrated in step 1 of FIG. 9A, the lock lever 40 swings clockwise in FIG. 9A against the urging force of the torsion spring 404. Then, due to the weight of the battery unit 30, the plurality of compression coil springs 226a (see FIG. 3) provided on the bottom surface of the battery housing portion 22 are compressed and deformed. The battery unit 30 stands still at a position where the weight of the battery unit 30 and the restoring force of the compression coil springs 226a are balanced, and enters a state illustrated in step 2 of FIG. 9B. In this state, the first engaging portion 402 of the lock lever 40 is in contact with the side surface 301 of the battery unit 30.

When the operator pushes down the battery unit 30 against the urging force of the compression coil springs 226a from the state illustrated in step 2 of FIG. 9B, the battery unit 30 is housed in the battery housing portion 22. When the battery unit 30 is in the housed state, the concave portion 302 formed on the side surface 301 of the battery unit 30 faces the first engaging portion 402 of the lock lever 40. As a result, the lock lever 40 swings counterclockwise in FIG. 9C, the first engaging portion 402 is engaged with the concave portion 302 of the battery unit 30 as illustrated in step 3 of FIG. 9C, and the battery unit 30 is fixed while being housed.

Therefore, the battery unit 30 cannot be removed unless the operation portion 401 is operated to disengage the first engaging portion 402. When the operation portion 401 is operated to disengage the first engaging portion 402, the battery unit 30 is moved toward the inlet side of the battery housing portion 22 by the urging force of the compression coil springs 226a, and enters the state illustrated in step 2 of FIG. 9B. Therefore, even if the operator stops operating the operation portion 401, the state (disengaged state) in which the first engaging portion 402 is disengaged from the concave portion 302 is maintained.

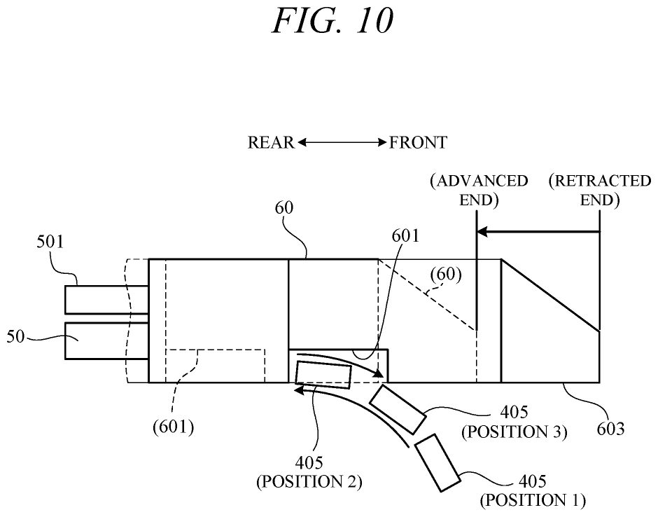

FIG. 10 is a diagram illustrating a positional relationship between the second engaging portion 405 and the notch 601 of the connector holding portion 60 in steps 1 to 3 of FIGS. 9A to 9C. In FIG. 10, the connector holding portion 60 is located at the retracted end illustrated in FIG. 7A. A broken line in FIG. 10 indicates a state in which the connector holding portion 60 has moved to the advanced end (connection position). In step 1 of FIG. 9A, the second engaging portion 405 is located at a position 1 illustrated in FIG. 10. In this case, since the second engaging portion 405 is disengaged from the notch 601, the connector holding portion 60 is in a slidable state.

When the state shifts from step 1 of FIG. 9A to step 2 of FIG. 9B, the second engaging portion 405 moves from the position 1 to a position 2 as illustrated in FIG. 10. In this case, since the second engaging portion 405 is engaged with the notch 601, the connector holding portion 60 can slide only by a gap between the second engaging portion 405 and the notch 601 in the front-rear direction. Therefore, the connector portion 50 held by the connector holding portion 60 cannot be connected to the connector portion 313 of the battery unit 30.

When the state shifts from step 2 of FIG. 9B to step 3 of FIG. 9C, the second engaging portion 405 moves from the position 2 to a position 3 as illustrated in FIG. 10, and the second engaging portion 405 is disengaged from the notch 601 so as to be slidable. Therefore, when the connector holding portion 60 holding the connector portion 50 is slid in the left direction (toward the rear side of the work machine) of FIG. 10, the connector portion 50 on the work machine side can be connected to the connector portion 313 (see FIG. 4) of the battery unit 30. In this case, since the connector holding portion 60 moves leftward from the position illustrated in FIG. 10, the second engaging portion 405 interferes with the lower surface 603 of the connector holding portion 60, and the second engaging portion 405 cannot be returned from the position 3 (step 3 in FIG. 9C) to the position 2 (step 2 in FIG. 9B) by operating the lock lever 40. That is, unless the connector portion 50 is disconnected and the connector holding portion 60 is moved to the retracted end, the operation of the lock lever 40 is prevented.

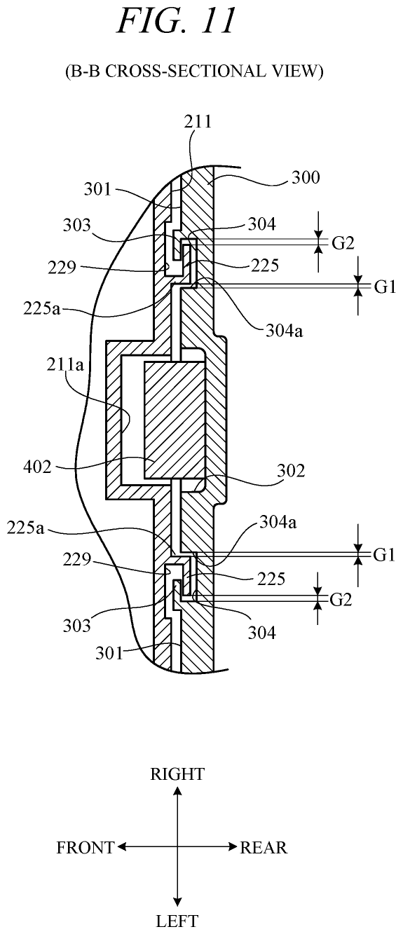

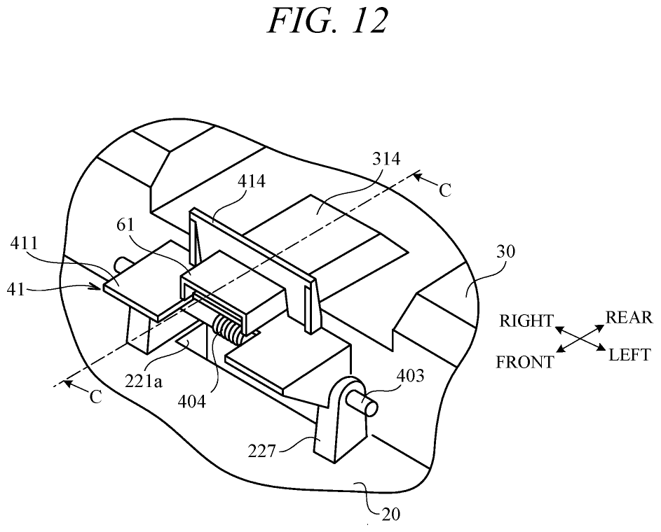

FIG. 11 is a cross-sectional view taken along line B-B of FIG. 9C. As illustrated in FIG. 3, the pair of projections 225 and the pair of concave portions 229 extending in an insertion direction (the front and back direction in the paper of FIG. 11) in which the battery unit 30 is inserted into the battery housing portion 22 are formed on the inner wall 221 of the battery housing portion 22. Meanwhile, as illustrated in FIG. 4, the pair of projections 303 and the pair of concave portions 304 extending in the insertion direction are formed on the side surface 301 of the battery unit 30. In this case, the projections 225 and the concave portions 229 constitute guiding portions, and the projections 303 and the concave portions 304 constitute guided portions.

Dimensions G1 and G2 of gaps between the projections 225 and the concave portions 304 in the left-right direction are set such that G1<G2 in the example illustrated in FIG. 11. Therefore, the amount of misalignment of the battery unit 30 in the left-right direction is regulated by the dimension G1 of each of the gaps. In this case, surfaces 225a of the projections 225 and surfaces 304a of the concave portions 304 function as a restricting portion for restricting the misalignment in the left-right direction. Of course, G1≥G2 may be set.

In FIG. 11, a guide mechanism including the guiding portions and the guided portions is provided on both left and right sides of the concave portion 302, but may be provided on only the left or right side of the concave portion 302. In addition, the concave portions 229 and the projections 303 may be omitted, and the projections 225 may be guiding portions and the concave portions 304 may be guided portions.

To house the battery unit 30 in the battery housing portion 22, the battery unit 30 is brought into contact with the guide 212 (see FIG. 8) to convey the battery unit 30 to the vicinity of the inlet of the battery housing portion 22. Next, as illustrated in FIG. 11, the position of the battery unit 30 is adjusted such that the projections 225 are located in the concave portions 304 and that the projections 303 are located in the concave portions 229. Then, the battery unit 30 is lowered while guiding the projections 303 and the concave portions 304 that are guided portions to the projections 225 and the concave portions 229 that are guiding portions, and the battery unit 30 is housed in the battery housing portion 22 as illustrated in step 3 of FIG. 9C.

As illustrated in step 3 of FIG. 9C, when the battery unit 30 is housed in the battery housing portion 22, the connector portion 313 on the battery unit side and the connector portion 50 on the work machine side face each other. In this state, as illustrated in FIG. 10, the second engaging portion 405 of the lock lever 40 is disengaged from the notch 601 of the connector holding portion 60. Therefore, the connector holding portion 60 at the retracted end illustrated in FIG. 7A is slid toward the advanced end against the urging force of the compression coil spring 702, and the connector portion 50 on the work machine side is connected to the connector portion 313 on the battery unit side. In the connector-connected state in which the connector holding portion 60 is located at the advanced end as indicated by the broken line in FIG. 10, even if the lock lever 40 is operated toward the side on which the battery is removed, that is, even if the second engaging portion 405 is moved from the position 3 to the position 2, the second engaging portion 405 interferes with the lower surface 603 of the connector holding portion 60 and the lever operation cannot be performed. In addition, in a case where the battery unit 30 is removed, when the connector portion 50 is disconnected and the connector holding portion 60 is moved to the retracted end, the second engaging portion 405 can swing to the notch 601 of the connector holding portion 60, so that the lock lever 40 can be operated.

### Second Embodiment

A battery housing structure according to a second embodiment will be described with reference to FIGS. 12 to 17. In the second embodiment, a configuration regarding the connection structure of a lock lever and a connector holding portion is different from that described in the first embodiment, and other configurations are similar to those described in the first embodiment. The configuration different from that described in the first embodiment will be described.

FIG. 12 is a diagram illustrating a portion including a lock lever 41 and a connector holding portion 61. The lock lever 41 is swingably attached to a shaft 403. The shaft 403 is supported by a pair of support columns 227. A barrier wall 414 is erected at the center of an upper surface of an operation portion 411 of the lock lever 41. A connector housing portion 314 of a connector portion 313 is formed so as to protrude upward at the center of an upper surface of a battery unit 30 in the left-right direction.

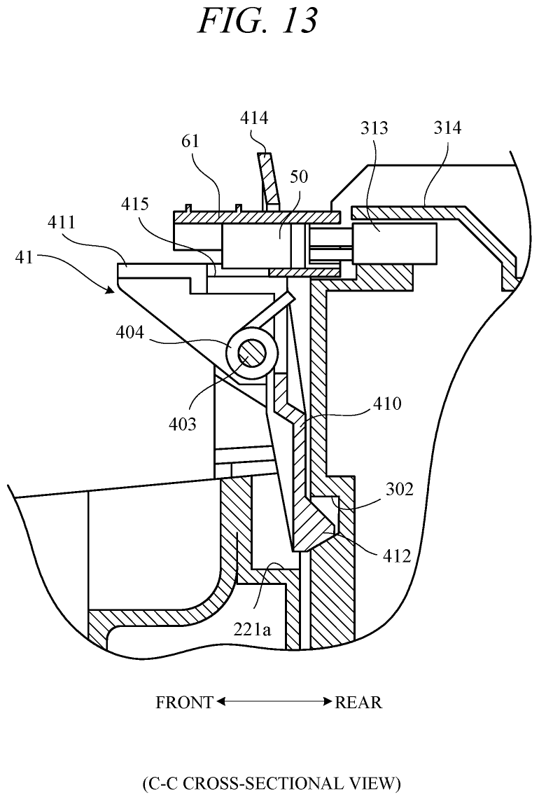

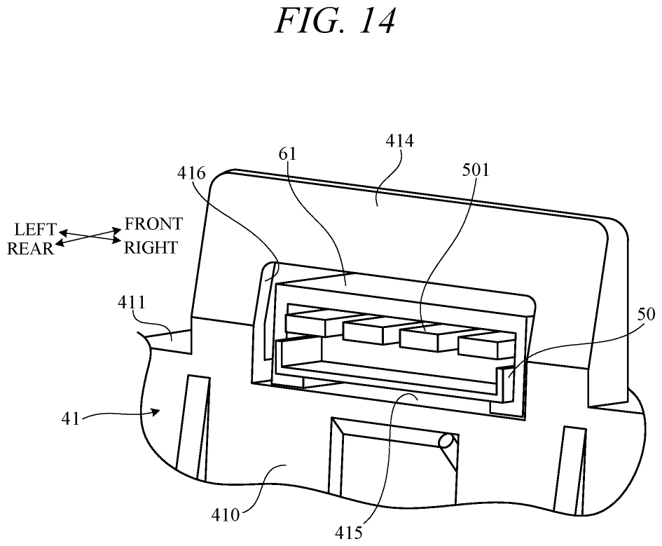

FIG. 13 is a cross-sectional view taken along line C-C of FIG. 12. At a lower end of a lever main body 410 of the lock lever 41, an engaging portion 412 which is an engaging projection is provided. The engaging portion 412 provided in the lever main body 410 is engaged with a concave portion 302 of the battery unit 30. The connector holding portion 61 faces the connector housing portion 314 of the battery unit 30. A connector portion 50 on the work machine side is connected to the connector portion 313 on the battery unit side.

FIG. 14 is a perspective view of a portion of the lock lever 41 where the barrier wall 414 is formed as viewed obliquely from the right rear side. A substantially rectangular opening 416 is formed below the barrier wall 414. A slide surface 415 on which the connector holding portion 61 slides in the front-rear direction is formed in a lower side portion of the opening 416. The connector portion 50 is held by the connector holding portion 61.

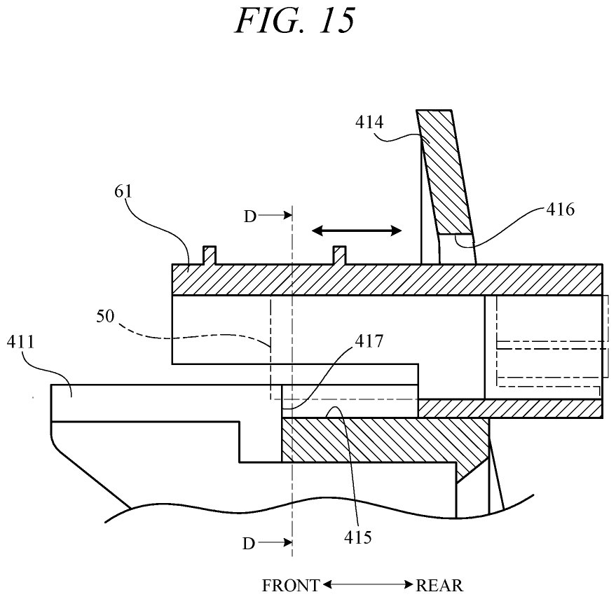

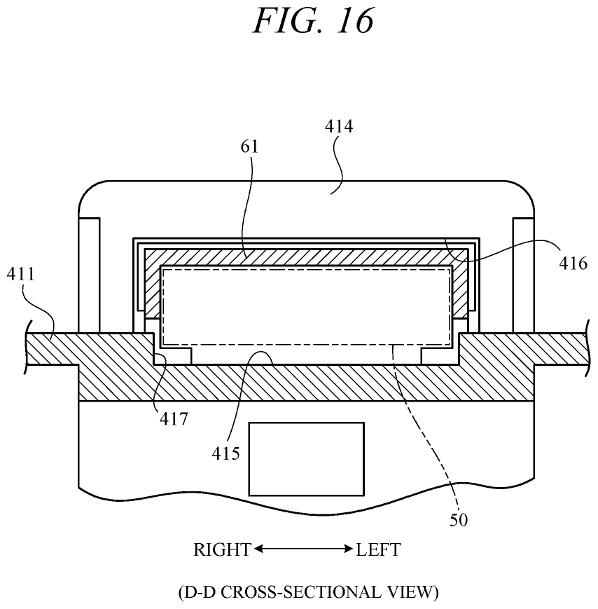

FIGS. 15 and 16 are diagrams illustrating a slide structure of the connector holding portion 61. FIG. 15 is a cross-sectional view of a work machine as viewed from the left direction. FIG. 16 is a cross-sectional view taken along line D-D of FIG. 15. In FIGS. 15 and 16, the connector portion 50 is indicated by a two-dot chain line. A concave portion 417 is formed on an upper surface of the operation portion 411, and a bottom surface of the concave portion 417 constitutes the slide surface 415 described above. The connector holding portion 61 is placed on the slide surface 415 and can freely slide in the front-rear direction of the work machine. A side wall of the concave portion 417 on the rear side functions as a stopper that defines the slide rear end position of the connector holding portion 61.

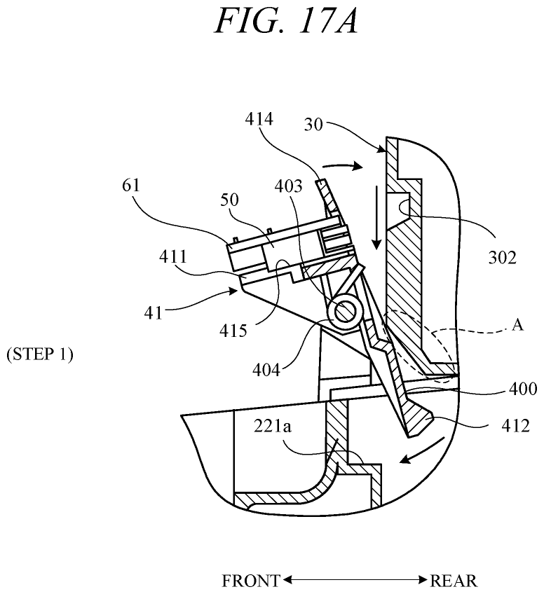

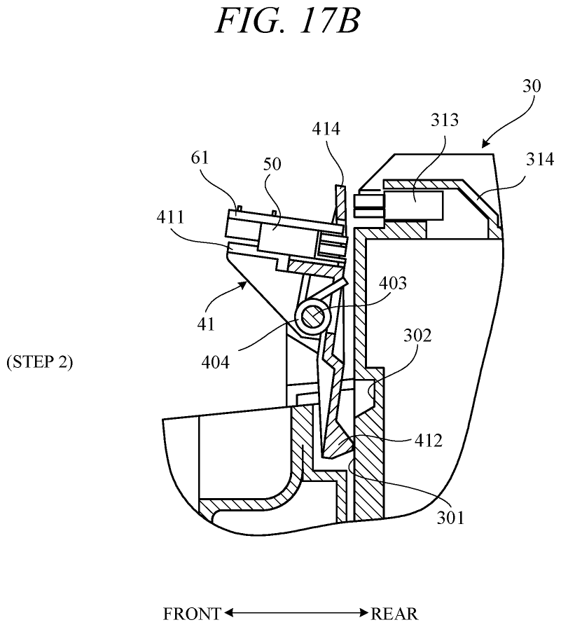

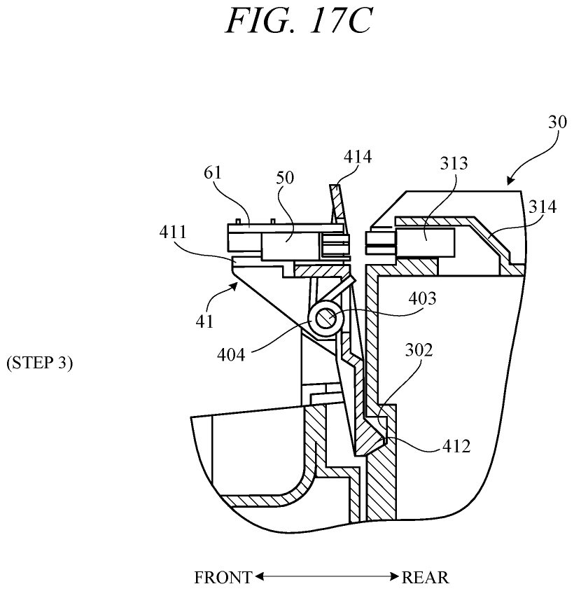

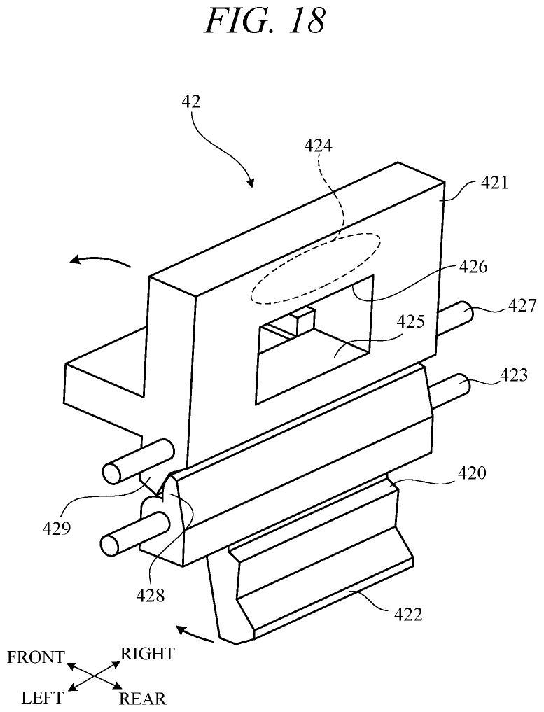

FIGS. 17A to 17C are diagrams for explaining an operation of housing the battery unit 30. As in the case of the first embodiment, when the battery unit 30 is lowered toward a battery housing portion 22, a lower end A of the battery unit 30 abuts on the lever main body 410 of the lock lever 41 in an initial positional state as illustrated in step 1 of FIG. 17A. In this state, the connector holding portion 61 is located at the slide rear end position on the slide surface 415 by its own weight.

When the battery unit 30 is further lowered from step 1 of FIG. 17A, the lock lever 41 swings clockwise in FIG. 17A against the urging force of a torsion spring 404 and enters a state illustrated in step 2 of FIG. 17B. In step 2, the engaging portion 412 of the lock lever 41 is in contact with a side surface 301 of the battery unit 30. In the state illustrated in step 2, the barrier wall 414 faces the connector portion 313. In this manner, since the barrier wall 414 faces the front surface of the connector portion 313 while being close to the connector portion 313, it is possible to prevent an erroneous operation of connecting the connector portion 50 to the connector portion 313 in the middle of the housing operation.

The battery unit 30 is further lowered from the state illustrated in step 2 of FIG. 17B, and housed in the battery housing portion 22 (step 3). As illustrated in step 3 of FIG. 17C, when the battery unit 30 is housed in the battery housing portion 22, the concave portion 302 formed on the side surface 301 faces the engaging portion 412 of the lock lever 41. As a result, the lock lever 41 swings counterclockwise in FIG. 17C, and the engaging portion 412 is engaged with the concave portion 302 of the battery unit 30. As described above, when the battery unit 30 is housed and fixed in the battery housing portion 22, the engaging portion 412 of the lock lever 41 is engaged with the concave portion 302 of the battery unit 30, and thus the battery unit 30 cannot be removed unless the engagement of the engaging portion 412 is released by operating the operation portion 411.

(Modifications)

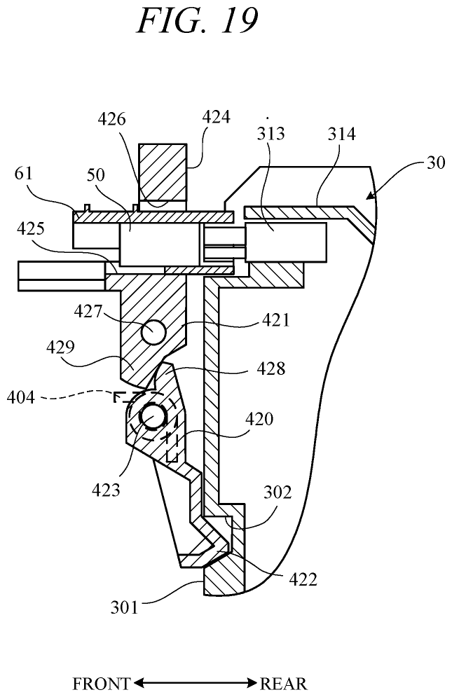

FIGS. 18 to 20 are diagrams illustrating a modification of the lock lever 41 described in the second embodiment. FIG. 18 is a perspective view of a lock lever 42. FIG. 19 is a cross-sectional view illustrating a relationship between the lock lever 42 and a battery unit 30. As illustrated in FIG. 18, in the lock lever 42 according to the modification, a lever main body 420 and an operation portion 421 are provided separately. The lever main body 420 is swingably attached to a shaft 423, and the operation portion 421 is swingably attached to a shaft 427. The shafts 423 and 427 are fixed to support columns 227 (see FIG. 12).

A cam portion 428 is provided at the upper end of the lever main body 420, and an engaging portion 422 which is an engaging projection is provided at the lower end of the lever main body 420. A cam portion 429 that comes into contact with the cam portion 428 is provided at the lower end of the operation portion 421. As illustrated in FIG. 19, the lever main body 420 is urged by a torsion spring 404 so as to swing counterclockwise in the drawing. Therefore, in a state where the battery unit 30 is housed in a battery housing portion 22, the engaging portion 422 of the lever main body 420 is engaged with a concave portion 302 of the battery unit 30.

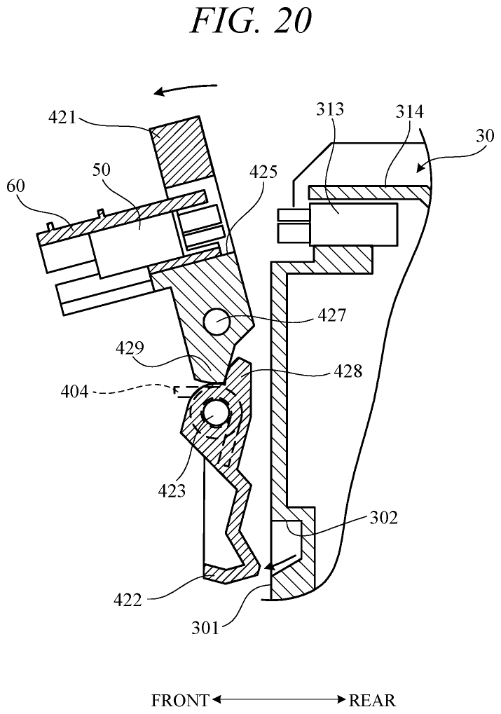

On the other hand, as illustrated in FIG. 18, the operation portion 421 is provided with a barrier wall portion 424, and a substantially rectangular opening 426 is formed below the barrier wall portion 424. A slide surface 425 on which a connector holding portion 61 slides in the front-rear direction is formed in a lower side portion of the opening 426. When the operation portion 421 is operated toward the front side of a work machine such that the upper end of the operation portion is separated from the battery unit 30, the cam portion 428 and the cam portion 429 are interlocked with each other, whereby the lever main body 420 swings clockwise in FIG. 18, and the engaging portion 422 moves so as to be separated from the battery unit 30. As a result, as illustrated in FIG. 20, the engagement between the engaging portion 422 and the concave portion 302 is released. FIG. 20 is a cross-sectional view in the released state. Before the operation portion 421 is operated to release the engagement, the connector holding portion 61 is slid to the retracted end, and a connector portion 50 is removed from a connector portion 313 in advance.

In the modification, since the operation direction of the operation portion 421 at the time of unlocking is the direction away from the battery unit 30, the lever operation direction and the unlocking direction are the same direction, and the operator can easily understand the unlocking operation. Also in the modification, similarly to the second embodiment described above, in a state similar to step 2 in FIG. 17 B, since the barrier wall portion 424 is located on the front surface of the connector portion 313, it is possible to prevent an erroneous operation of connecting the connector portion 50 to the connector portion 313 in the middle of the housing operation.

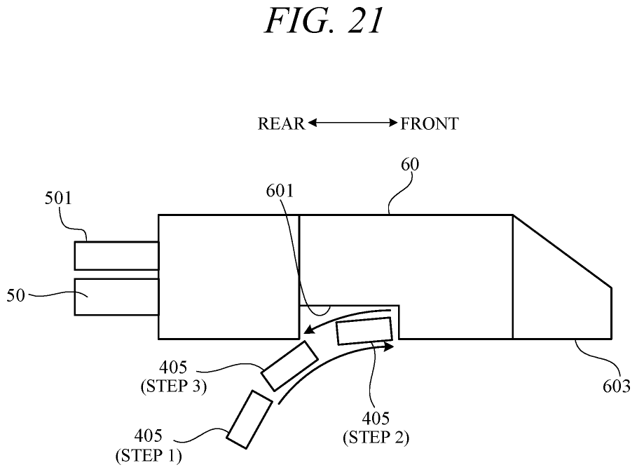

Note that, in FIGS. 18 to 20, the modification of the lock lever 41 described in the second embodiment has been described, but the configurations of the lever main body 420 and the operation portion 421 illustrated in FIG. 18 can also be used in the lock lever 40 described in the first embodiment. In this case, the second engaging portion 405 is provided in the operation portion 421, and the engagement operation between the second engaging portion 405 and the notch 601 is as illustrated in FIG. 21. Steps 1 to 3 in FIG. 21 correspond to steps 1 to 3 in FIGS. 9A to 9C. In this case, the second engaging portion 405 enters the notch 601 of the connector holding portion 60 located at the retracted end from the rear side.

According to the embodiments and the modifications of the present invention described above, the following operational effects are obtained.

(C1) As illustrated in FIGS. 2 to 5, 9A to 9C, 10, and the like, the battery housing structure includes the battery housing portion 22 that houses the battery unit 30 having the connector portion 313, the connector portion 50 to be connected to the connector portion 313, and the lock lever 40 that includes the second engaging portion 405 serving as a connection prevention portion and configured to prevent connection between the connector portion 313 and the connector portion 50, and serves as a fixing tool that fixes the battery unit 30 to the battery housing portion 22. The battery unit 30 has the concave portion 302 provided to face the inner wall 221 of the battery housing portion 22. The lock lever 40 is a swing lever that includes the first engaging portion 402 as an engaging projection at one end and the second engaging portion 405 at the other end, and swings about the shaft 403 provided between the one end and the other end. Then, the lock lever 40 swings between the first position (position in step 3 in FIG. 9C) where the first engaging portion 402 is engaged with the concave portion 302 and the battery unit 30 is fixed to the battery housing portion 22 and the second position (position in step 2 in FIG. 9B) where the first engaging portion 402 and the concave portion 302 are not engaged and the second engaging portion 405 is located at the connection prevention position (position 2 in FIG. 10) according to the amount of insertion of the battery unit 30 in the battery housing portion 22.

As described above, in a state where the first engaging portion 402 and the concave portion 302 are not engaged and the battery unit 30 is not fixed to the battery housing portion 22, the second engaging portion 405 of the lock lever 40 is located at the connection prevention position (position 2 in FIG. 10). Since the connector holding portion 60 is locked by the second engaging portion 405, connection between the connector portion 313 and the connector portion 50 is prevented. As a result, it is possible to prevent erroneous connector connection in a state where the battery unit 30 is not housed and fixed in the battery housing portion 22. Furthermore, in a case where the battery unit 30 is removed from the battery housing portion 22, in a state where the connector portion 50 is connected, the second engaging portion 405 interferes with the lower surface 603 of the connector holding portion 60, and it is not possible to return the battery unit 30 from the position 3 (step 3 in FIG. 9C) to the position 2 (step 2 in FIG. 9B) by operating the lock lever 40. As a result, it is possible to prevent the battery unit from being erroneously unfixed in a state where the connector portion 50 is connected.

(C2) In (C1) above, as illustrated in FIGS. 5, 7A, 7B, 9A to 9C, 10, and the like, the battery housing structure further includes the connector holding portion 60 that holds the connector portion 50 and is movable between the connector connection position (advanced end in FIG. 7B) and the connector non-connection position (retracted end in FIG. 7A), the connector holding portion 60 has the notch 601 with which the second engaging portion 405 as the connection prevention portion can be engaged, and the lock lever 40 swings, according to the amount of insertion of the battery unit 30 in the battery housing portion 22, to the first position (position in step 3 in FIG. 9C) where the first engaging portion 402 is engaged with the concave portion 302 and the battery unit 30 is fixed to the battery housing portion 22, and to the second position (position in step 2 in FIG. 9B) where the first engaging portion 402 and the concave portion 302 are not engaged and the second engaging portion 405 is engaged with the notch 601 to lock the connector holding portion 60 to the connector non-connection position (retracted end illustrated in FIG. 7A).

In a state where the first engaging portion 402 and the concave portion 302 are not engaged and the battery unit 30 is not fixed to the battery housing portion 22, the second engaging portion 405 is engaged with the notch 601 to lock the connector holding portion 60 to the connector non-connection position (retracted end illustrated in FIG. 7A). As a result, it is possible to prevent erroneous connector connection in a state where the battery unit 30 is not housed and fixed in the battery housing portion 22.

(C3) In (C1) above, as illustrated in FIGS. 13, 17, and the like, in a state where the battery unit 30 is not fixed to the battery housing portion 22, that is, in a state in which the lock lever 41 is at the swinging position illustrated in step 2 in FIG. 17B, the barrier wall 414 provided at one end of the lock lever 41 is disposed at a position facing the connector portion 313 which is at the connection prevention position. Since the barrier wall 414 faces the connector portion 313, connection between the connector portion 313 and the connector portion 50 is prevented.

(C4) In (C1) above, as illustrated in FIGS. 18 to 20 and the like, the lock lever 42 includes the lever main body 420 that includes the engaging portion 422 as an engaging projection at one end and the cam portion 428 as a first action portion at the other end and serves as a first swing lever that swings about the shaft 423 provided between the engaging portion 422 and the cam portion 428, and the operation portion 421 that includes the cam portion 429 interlocked with the cam portion 428 at one end and the barrier wall portion 424 at the other end, and serves as a second swing lever that swings about the shaft 427 provided between the cam portion 429 and the barrier wall portion 424. When the upper end of the operation portion 421 moves away from the side surface 301 on which the concave portion 302 of the battery unit 30 housed in the battery housing portion 22 is formed, the engaging portion 422 in the engaged state is disengaged from the concave portion 302. As described above, since the operation direction of the operation portion 421 at the time of unlocking is the direction away from the battery unit 30, the lever operation direction and the unlocking direction are the same direction, and the operator can easily understand the unlocking operation.

(C5) In (C1) above, as illustrated in FIGS. 9A to 9C and the like, the battery housing structure further includes the torsion spring 404 that causes the first engaging portion 402 to protrude from the inner wall 221 toward the battery housing portion 22 and presses the first engaging portion 402 against the concave portion 302. As a result, it is possible to prevent misalignment (in particular, misalignment in the pressing direction) of the battery unit 30 due to vibration or the like. By suppressing misalignment of the battery unit 30 provided with the connector portion 313, it is possible to suppress application of an unnecessary force to the connector portions 50 and 313 in the connected state.

(C6) In (C1) above, as illustrated in FIGS. 9A to 9C and the like, the lock lever 40 includes the operation portion 401 for releasing engagement between the first engaging portion 402 and the concave portion 302 by lever operation, and when the operation portion 401 approaches the side surface 301 on which the concave portion 302 of the battery unit 30 housed in the battery housing portion 22 is formed, the first engaging portion 402 in the engaged state is disengaged from the concave portion 302. Since the lock lever 40 is provided with the operation portion 401 that can be manually operated, the disengagement operation is easily performed, and operability can be improved.

(C7) In (C1) above, as illustrated in FIGS. 3, 9A to 9C, and the like, the battery housing portion 22 includes the compression coil springs 226a that urge the battery unit 30 housed in the battery housing portion 22 toward the inlet side of the battery housing portion 22 with an urging force larger than the weight of the battery unit 30. When the operation portion 401 is operated to disengage the first engaging portion 402 in the state in step 3 in FIG. 9C, the battery unit 30 is moved toward the inlet of the battery housing portion 22 by the urging force of the compression coil springs 226a, and enters the state indicated in step 2 in FIG. 9B. Therefore, even if the operator stops operating the operation portion 401, the disengaged state of the first engaging portion 402 is maintained, and the workability at the time of removing the battery unit 30 from the battery housing portion 22 can be improved.

(C8) In (C1) above, as illustrated in FIGS. 9A to 9C, 11, and the like, the battery housing structure further includes the guide mechanism including the projections 303 and the concave portions 304 serving as guided portions and provided on the side surface 301 having the concave portion 302 of the battery unit 30, and the projections 225 and the concave portions 229 serving as guiding portions and provided on the inner wall 221 of the battery housing portion 22 to guide the projections 303 and the concave portions 304 in the insertion direction in which the battery unit 30 is inserted into the battery housing portion 22. The guide mechanism includes the surfaces 225a and 304a that restrict misalignment of the battery unit 30 with respect to the battery housing portion 22 in a direction orthogonal to the swing surface of the lock lever 40. The swing surface of the lock lever 40 is a surface orthogonal to the shaft 403, and the direction orthogonal to the swing surface is the left-right direction in FIG. 11.

By providing such a guide mechanism, the battery unit 30 can be housed at a predetermined housing position, and it is possible to prevent inconvenience from occurring in fixing the battery unit 30 by the lock lever 40 and connecting the connector portions 50 and 313. Since the fixing and the connector connection of the battery unit 30 are performed in the region where the inner wall 221 is provided, the guide mechanism is preferably provided on the inner wall 221.

Note that a guide mechanism may also be provided on another inner wall of the battery housing portion 22. However, if the number of guide mechanisms increases, positioning of the battery unit 30 becomes difficult or resistance at the time of guiding increases. Therefore, the number of guide mechanisms is preferably small as long as there is no hindrance to the guide.

(C9) In (C2) above, as illustrated in FIG. 7A and the like, the battery housing structure further includes the compression coil spring 702 that applies, to the connector holding portion 60, an urging force for moving the connector holding portion 60 toward the retracted end which is at the connector non-connection position. In a case where the battery unit 30 is housed in the battery housing portion 22, since the connector holding portion 60 is held at the retracted end which is at the retracted position by the compression coil spring 702, it is possible to prevent the connector portion 50 from interfering with the battery unit 30 and being damaged.

(C10) The work machine has the battery housing structure described in any one of (C5) to (C9) above, and as illustrated in FIGS. 1 to 3 and the like, the battery housing portion 22 and the lock lever 40 are disposed along a traveling direction (front-rear direction) of the work machine 100. Since the work machine 100 has larger vibration (acceleration) in the front-rear direction in the traveling direction than in the left-right direction, the vibration of the battery unit 30 can be suppressed by arranging the lock lever 40 for fixing the battery unit 30 along the traveling direction.

(C11) In (C10) above, as illustrated in FIGS. 1, 2, 8, and the like, the work machine includes the upper cover 21 that covers at least the battery housing structure and includes the opening/closing portion 210 that is provided above the battery housing structure and opens and closes with the shaft 213 disposed on the rear side of the work machine with respect to the battery housing portion 22 as the rotation axis. The battery housing structure is mounted such that the battery housing portion 22 is disposed on the shaft 213 side and the lock lever 40 is disposed on the opposite side of the shaft 213. Therefore, the opening/closing portion 210 is less likely to interfere when the connector portion 50 is inserted into or removed from the connector portion 313 or when the lock lever is operated.

(C12) In (C11) above, as illustrated in FIGS. 2, 8, and the like, the upper cover 21 has the guide 212 that is provided vertically above the inlet of the battery housing portion 22, that is, above the upper ends of inner walls 221 to 224, serves as a positioning member for positioning the battery unit 30 above the battery housing portion 22, and is on the shaft 213 side with respect to the battery housing portion 22. By positioning the battery unit 30 on the rear side of the work machine by the guide 212, the battery unit 30 can be easily positioned in the vicinity of the inlet of the battery housing portion, and it is possible to easily perform the work of loading the battery unit 30 to the inlet of the battery housing portion.

In the examples illustrated in FIGS. 2, 8, and the like, the guide 212 as the positioning portion is provided in the upper cover 21, but a positioning portion may be integrally formed on the upper portion of the inner wall 223 of the battery housing portion 22.

Although the battery housing structure of the work machine has been described as an example in each of the embodiments, the battery housing structure according to the present invention can also be used as a battery housing structure of a battery charging device, a battery housing structure of a battery unit mounted on a construction machine, and the like.

The above embodiment can be combined as desired with one or more of the aforesaid modifications. The modifications can also be combined with one another.

According to the present invention, it is possible to prevent connector connection in a state in which the battery unit is not fixed and to prevent unfixing of the battery unit in a state in which the connector portions are connected.

Above, while the present invention has been described with reference to the preferred embodiments thereof, it will be understood, by those skilled in the art, that various changes and modifications may be made thereto without departing from the scope of the appended claims.

1. A battery housing structure, comprising:
a housing portion configured to house a battery unit including a first connector;
a second connector configured to be connected to the first connector; and
a fixing tool configured to fix the battery unit to the housing portion and including a connection prevention portion configured to prevent connection between the first connector and the second connector when located at a connection prevention position, wherein
the battery unit includes a concave portion facing an inner wall of the housing portion, wherein
the fixing tool is a swing lever including a projection at one end and the connection prevention portion at the other end, and configured to swing about a shaft provided between the one end and the other end, wherein
the swing lever is configured to swing between: a first position where the projection is engaged with the concave portion and the battery unit is fixed to the housing portion; and a second position where the projection is not engaged with the concave portion and the connection prevention portion is located at the connection prevention position, in accordance with an amount of insertion of the battery unit into the housing portion.

2. The battery housing structure according to claim 1, further comprising:
a connector holding portion configured to hold the second connector and movable between a connector connection position and a connector non-connection position, wherein
the connector holding portion includes a notch configured to be engaged with the connection prevention portion when the connector holding portion is located at the connector non-connection position, wherein
the swing lever is configured to swing between: the first position where the projection is engaged with the concave portion and the battery unit is fixed to the housing portion; and the second position where the projection is not engaged with the concave portion and the connection prevention portion is engaged with the notch to lock the connector holding portion to the connector non-connection position, in accordance with an amount of insertion of the battery unit into the housing portion.

3. The battery housing structure according to claim 1, wherein
the connection prevention position is a position facing the first connector.

4. The battery housing structure according to claim 1, wherein
the swing lever includes:
a first swing lever including the projection at one end and a first action portion at the other end, and configured to swing about a first shaft provided between the projection and the first action portion; and
a second swing lever including a second action portion interlocked with the first action portion at one end and an operation portion including the connection prevention portion at the other end, and configured to swing about a second shaft provided between the second action portion and the connection prevention portion, wherein
the projection engaged with the concave portion is disengaged from the concave portion when the operation portion moves away from a surface on which the concave portion of the battery unit housed in the housing portion is formed.

5. The battery housing structure according to claim 1, further comprising:
a first urging portion configured to cause the projection to protrude from the inner wall toward the housing portion to press the projection against the concave portion.

6. The battery housing structure according to claim 1, wherein
the swing lever includes an operation portion for releasing engagement between the projection and the concave portion by a lever operation, wherein
the projection engaged with the concave portion is disengaged from the concave portion when the operation portion approaches a surface on which the concave portion of the battery unit housed in the housing portion is formed.

7. The battery housing structure according to claim 1, wherein
the housing portion includes a second urging portion configured to urge the battery unit housed in the housing portion toward an inlet side of the housing portion with an urging force larger than a weight of the battery unit.

8. The battery housing structure according to claim 1, further comprising:
a guide mechanism including:
a guided portion provided on a surface including the concave portion of the battery unit; and
a guiding portion provided on the inner wall of the housing portion to guide the guided portion in an insertion direction of the battery unit into the housing portion, wherein
the guide mechanism includes a restricting portion configured to restrict misalignment of the battery unit with respect to the housing portion in a direction orthogonal to a swing surface of the swing lever.

9. The battery housing structure according to claim 2, further comprising:
a third urging portion configured to apply an urging force to the connector holding portion to move the connector holding portion toward the connector non-connection position.

10. A work machine, comprising:
the battery housing structure according to claim 1, wherein
the housing portion and the fixing tool are disposed along a moving direction of the work machine.

11. The work machine according to claim 10, further comprising:
a cover configured to cover at least the battery housing structure and including a cover opening/closing portion above the battery housing structure, the cover opening/closing portion being configured to open and close the cover with a shaft disposed on a rear side of the work machine with respect to the housing portion as a rotation axis, wherein
the battery housing structure is mounted on the work machine such that the housing portion is disposed on a side of the shaft and the fixing tool is disposed on an opposite side of the shaft.

12. The work machine according to claim 11, further comprising:
a positioning member provided vertically above an inlet of the housing portion and configured to position the battery unit above the housing portion, on the side of the shaft with respect to the housing portion.
